(19) United States
(12) Patent Application Publication
(10) Pub. No.: US 2025/0220084 A1
(43) Pub. Date: Jul. 3, 2025

(54) ARTIFICIAL INTELLIGENCE PROFILE GENERATION

(71) Applicant: eBay Inc., San Jose, CA (US)

(72) Inventors: Harikrishnan Kuppusamykrishnan, San Francisco, CA (US); Aaron Michael Nance, Troutdale, OR (US); Anna Monika Zaremba, Kirkland, WA (US)

(73) Assignee: eBay Inc., San Jose, CA (US)

(21) Appl. No.: 18/400,008

(22) Filed: Dec. 29, 2023

(51) Int. Cl. H04L 67/306; G06F 40/40; G06Q 30/0601; G06T 11/00

(52) U.S. Cl. CPC H04L 67/306; G06F 40/40; G06Q 30/0641; G06T 11/00

(57) ABSTRACT

Artificial Intelligence profile generation techniques are described. In an implementation, a profile manager service is configured to generate a profile, automatically and without user intervention. To do so, the profile manager service utilized a prompt generator module and a profile generation module. The prompt generator module is implemented by a machine-learning model using generative artificial intelligence to generate prompts to guide input of characteristics to be used as part of profile generation. The profile generator module is implemented by a machine-learning model using generative artificial intelligence. The profile generator module is configured to generate a candidate profile based on the characteristics received over a series of iterations in response to the prompts generated by the prompt generator module.

### BACKGROUND

Listing services are implemented as digital services by service provider systems to make a wide range of functionality available to client devices via a network, e.g., the Internet. As part of this, the listing services often support an ability to manage a presence of entities (e.g., branding) that participate as part of the listing services, whether as a source of the listings or as a consumer of the listings.

However, conventional techniques supported by listing services to manage the entity's presence are typically disjointed and involve significant amounts of manual interactions that leverage specialized knowledge to implement. Accordingly, conventional techniques generally involve inefficient use of computation resources by computing devices that implement the service provider systems as well as user frustration.

### SUMMARY

Artificial Intelligence profile generation techniques are described. In an implementation, a profile manager service is configured to generate a profile, automatically and without user intervention. To do so, the profile manager service utilizes a prompt generator module and a profile generation module. The prompt generator module, in one or more examples, is implemented by a machine-learning model using generative artificial intelligence to generate prompts to guide input of characteristics to be used as part of profile generation.

The profile generator module, in one or more examples, is implemented by a machine-learning model using generative artificial intelligence. The profile generator module is configured to generate a candidate profile based on the characteristics received over a series of iterations in response to the prompts generated by the prompt generator module. The candidate profiles include a digital image and text configured for use in conjunction with a listing for a product or service by a listing service implemented by a service provider system.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of an environment in an example implementation that is operable to employ artificial intelligence profile generation techniques described herein.

FIG. 2 depicts a system in an example implementation showing operation of a profile manager service of FIG. 1 in greater detail.

FIG. 3 depicts an example implementation of a first set of prompts as output as an initial prompt for display in a user interface.

FIG. 4 depicts an example implementation of a second set of prompts as output for display in a user interface that are usable to refine a candidate profile.

FIG. 5 depicts a system in an example implementation showing operation of a prompt generator module and the profile generator module of the profile manager service of FIG. 2 in greater detail as employing machine learning.

FIG. 6 depicts a system in an example implementation showing training of machine-learning models usable to implement the profile manager service of FIG. 1 in greater detail.

FIG. 7 depicts a system in an example implementation showing artificial intelligence profile generation by a profile manager service in greater detail.

FIG. 8 is a flow diagram depicting a step-by-step procedure in an example implementation of operations performable by a processing device for accomplishing a result of generating a profile using generative artificial intelligence implemented using a machine-learning model by leveraging prompt generation.

FIG. 9 is a flow diagram depicting a step-by-step procedure in an example implementation of operations performable by a processing device for accomplishing a result of generating a profile using generative artificial intelligence implemented using a machine-learning model by leveraging iterative candidate profile generation.

FIG. 10 illustrates an example system including various components of an example device that can be implemented as any type of computing device as described and/or utilize with reference to the previous figures to implement embodiments of the techniques described herein.

### DETAILED DESCRIPTION

### Overview

Profiles are used as part of listing services for identity representation (e.g., branding) of entities that participate in the listing services, examples of entities include a source of a listing as well as consumers of the listings. Conventional techniques implemented by service provider systems to create and manage profiles, however, involve numerous technical challenges that are typically cumbersome and involve specialized knowledge on the part of the entities to manually implement. Casual users, for instance, may not have specialized knowledge usable to create a compelling logo, lack an ability to express, textually, the identity being represented (e.g., as a seller, a seller's products, a buyer), and so on.

Generation of a profile, for instance, may be performed as part of implementing a brand by an entity as part of a comprehensive strategy to uniquely identify the entity, e.g., a seller, a buyer, and so forth. Accordingly, conventional techniques used to generate a profile involve an understanding of a brand identity, creation of a brand name and logo, identification of visual elements usable to uniquely identify the entity, and so forth. Consequently, it has been observed that in real world scenarios more than half of the entities associated with listing services forgo use of profiles as part of identity representation, thereby avoiding use of a potentially valuable technique to encourage trust and extend reach of the entities within the listing services.

Accordingly, artificial intelligence profile generation techniques are described to address these and other technical challenges involved in generating a profile, examples of which include brand consistency, logo identification, and text generation as described above. These techniques are operable to improve efficiency in user interaction by assisting profile generation utilizing generative artificial intelligence (AI) implemented using one or more machine-learning models. A profile manager service, for instance, leverages generative AI to generate a profile for an entity based on listings already generated by the entity or other entities as part of a listing service, e.g., to offer products or services for sale. The listings provide insights that are leveraged as part of generative AI, automatically and without user intervention, into characteristics of the entity, products or services offered by the entity, and so forth that are then usable to generate the profile.

The listings, in one or more examples, exhibit a brand consistency which may then be identified and leveraged as part of generative AI in creating a profile for a corresponding entity. Use of user prompts is also supported by the profile manager service as part of an iterative process to generate and refine profiles. Candidate profiles, for instance, may be generated that are refined based on inputs received responsive to prompts output in a user interface, based on previously generated profiles, and so forth. As a result, the profile listing service is configurable to increase user efficiency and efficiency of computing devices that implement the listing service by generating a candidate profile as a starting point which may then further modified as desired. As a result, efficiency of computational resources utilized by service provider systems by the computing devices to implement these techniques for potentially millions of entities is also improved by reducing an amount of user interaction involved in generating a profile as compared with conventional manual profile generation techniques that involved significant amounts of time to perform, thereby also reducing power consumption.

In one or more examples, a profile manager service is leveraged to generate profiles that are utilized by a service provider system in conjunction with one or more digital services. The profiles are representative of respective entities, contemplated interaction of the entities as part of the digital services, branding employed by the entities for source identification, and so on.

The profile manager service, for instance, employs generative artificial intelligence to generate profiles using a machine-learning model. To do so, the profile manager service employs a prompt generator module to generate prompts that are output via a user interface to guide entry of characteristics for use in generating a profile. A profile generator module then generates the profile based on profile inputs received via the user interface based on the prompts from the prompt generator module. This process may be performed by the profile manager service over a series of back-and-forth iterations between these modules to generate candidate profiles and refine the candidate profiles over a series of user interactions until a desired profile is achieved.

The prompt generator module, for instance, is configured to generate an initial set of prompts, e.g., to specify a product or service that is a subject of listings by an entity, characteristics of the product or service, a style to be used in generating the profile, and so forth. In an implementation, the prompt generator module employs generative artificial intelligence implemented using a machine-learning model in the generation of the prompts, e.g., using a large language model (LLM) implemented using an artificial neural network such as neural network based on transformer architecture. The prompt generator module, for instance, identifies listings associated with an entity that is to be a subject of the profile. Examples of entities include a source of a listing as well as consumers of the listings as part of a listing service as well as entities associated with other digital services, e.g., social media digital services, streaming digital services, and so on. The prompt generator module then utilizes the listings as a basis to generate prompts, e.g., to form questions, prepopulate answers to prompts, and so forth.

A set of characteristics received as inputs via the user interface in response to the initial set of prompts is then processed by the profile generator module. The profile generator module, for instance, may also employ generative artificial intelligence techniques implemented using a machine-learning model. The profile generator in this example is configurable to generate text (e.g., using a large language model implemented using a neural network) and digital images (e.g., using a diffusion model) to form an initial candidate profile based on the inputs. Other examples are also contemplated, including use of a single model to generate and analyze both text and digital images implemented as a multimodal large language model The profile generator module may also leverage supporting information of the entity to do so, such as listings employed by the entity or other entities as part of the listing service or elsewhere. The profile generator module may do so by accessing links and credentials for other service provider systems as provided by the entity, e.g., to access a social media service, online news service, and so forth.

The candidate profile generated by the profile generator module is then output for display in a user interface. The prompt generator module may then output prompts that are usable to further refine the candidate profile. The prompts, for instance, may be generated by the prompt generator module, automatically and without user intervention, based on the initial set of characteristics, the listings associated with the entity, the initial candidate profile itself, and so on. This process may repeat over a number of iterations until a desired profile is generated, which is then associated with the entity as part of the listing service. In this way, the profile manager service overcomes conventional technical challenges in order to efficiently generate profiles and as such extends the availability of profiles to entities that interact with the listing service or other digital services, which is not possible in conventional techniques. Further discussion of these and other examples is included in the following sections and shown in corresponding figures.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Identity Verification Environment

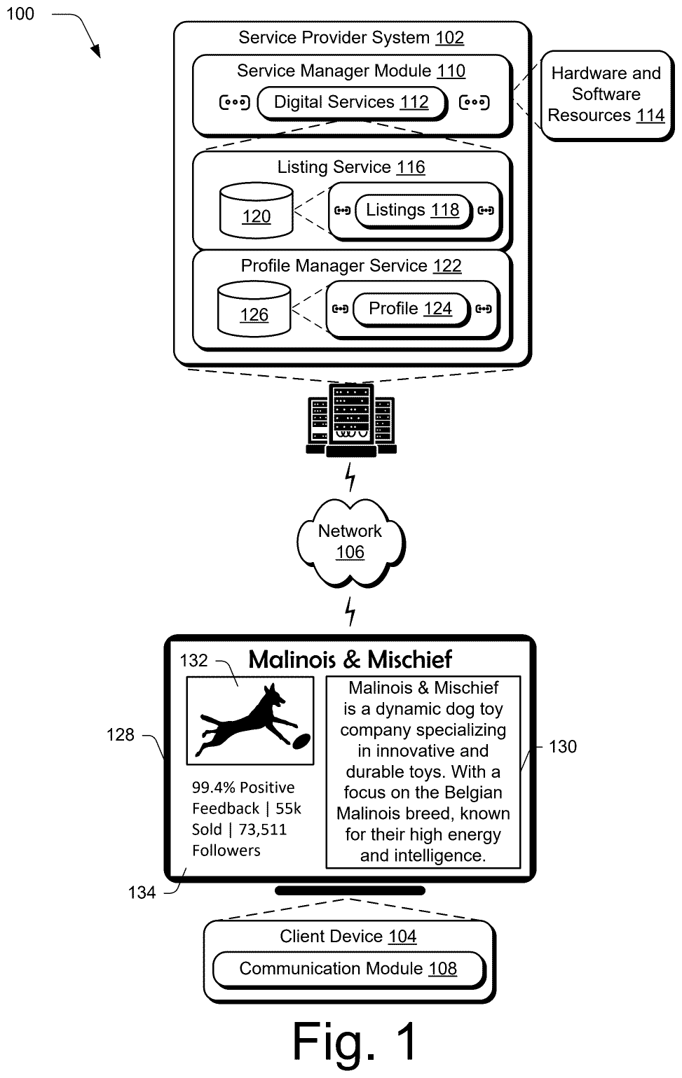

FIG. 1 is an illustration of an environment 100 in an example implementation that is operable to employ artificial intelligence profile generation techniques described herein. The illustrated environment 100 includes a service provider system 102 and a client device 104 that are communicatively coupled, one to another, via a network 106. Computing devices that implement the service provider system 102 and the client device 104 are configurable in a variety of ways.

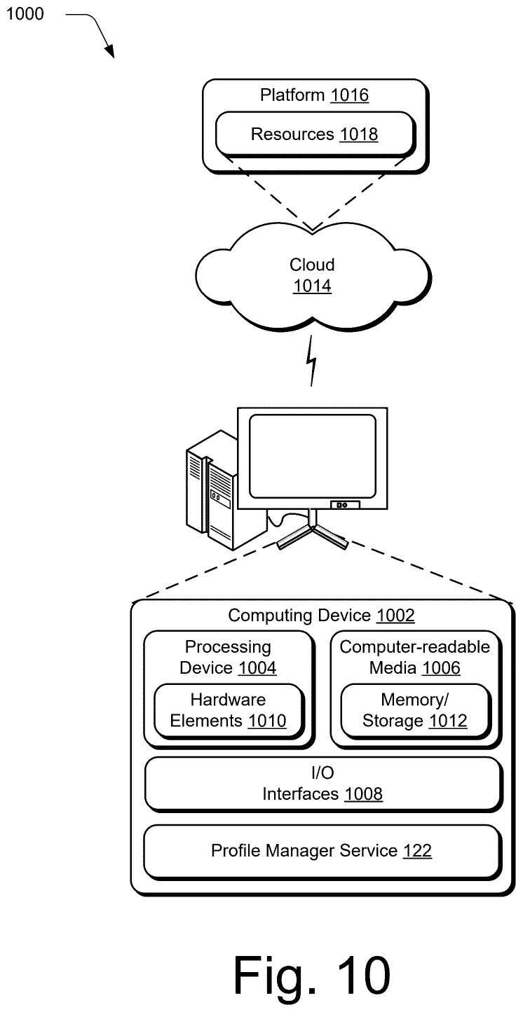

A computing device, for instance, is configurable as a desktop computer, a laptop computer, a mobile device (e.g., assuming a handheld configuration such as a tablet or mobile phone as illustrated), and so forth. Thus, a computing device ranges from full resource devices with substantial memory and processor resources (e.g., personal computers, game consoles) to a low-resource device with limited memory and/or processing resources (e.g., mobile devices). Additionally, although a single computing device is shown, a computing device is also representative of a plurality of different devices, such as multiple servers utilized by a business to perform operations “over the cloud” as described in FIG. 10.

The client device 104 includes a communication module 108 that is representative of functionality to communicate via the network 106 with a service manager module 110 of the service provider system 102, e.g., as a browser, a network-enabled application, and so on. The service manager module 110 is configured to implement digital services 112 using hardware and software resources 114, e.g., a processing device and a computer-readable storage medium. Digital services 112 are usable to expose a variety of functionality to the client device 104 via the network through execution by computing devices at the service provider system 102. Examples of digital services including social media service, digital content creation services, streaming services, digital content storage services, and so forth.

A listing service 116, for instance, is an example of the digital services 112 that supports functionality involving the creation, management, and control of access to listings 118, which are illustrated as maintained in a storage device 120. The listings 118, for instance, are usable to implement branding to list products or services that are made available for sale via the listing service 116, e.g., by auction, for purchase, lease, rent, and so forth. Branding, for instance, is usable to uniquely identify an entity and products or services associated with that entity from other entities through distinctive designs, e.g., of the products themselves, digital content associated with the entity, and so forth.

Accordingly, in this instance an entity may be associated with the listing service 116 as a source of the listings that has a product or service available, and another entity as a consumer of the listings 118 views the listings to locate products or services of interest. Other examples are also contemplated, including listings configured as social media posts, for items of digital content (e.g., digital music, digital video, digital books), and so forth.

Another example of the digital services 112 is illustrated as a profile manager service 122. The profile manager service 122 is representative of functionality to generate (e.g., create, edit, and update), manage, and control access a profile 124, which is illustrated as maintained in a storage device 126. The profile 124 is configured as representative of an entity and/or listings 118 associated with the entity as part of the listing service 116.

As shown as displayed in a user interface 128 at the client device 104, for instance, a profile includes profile text data 130 which is a textual description of characteristics of an entity, characteristics of listings 118 associated with the entity, and so on. The profile also includes a digital image 132 as representative of the entity, e.g., a logo digital image. Other information may also be included as part of the profile, e.g., metrics 134 regarding the entity as part of the listing service 116. The profile 124, as output with or selectable from the listings 118, supports an additional degree of trust of the associated entity in real world scenarios. Accordingly, generation of the machine-learning models by the profile manager service 122 expands this functionality over that available from conventional techniques, further discussion of which is included in the following sections.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Example Artificial Intelligence Profile Generation Techniques

The following discussion describes artificial intelligence profile generation techniques that are implementable utilizing the described systems and devices. Aspects of each of the procedures are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm.

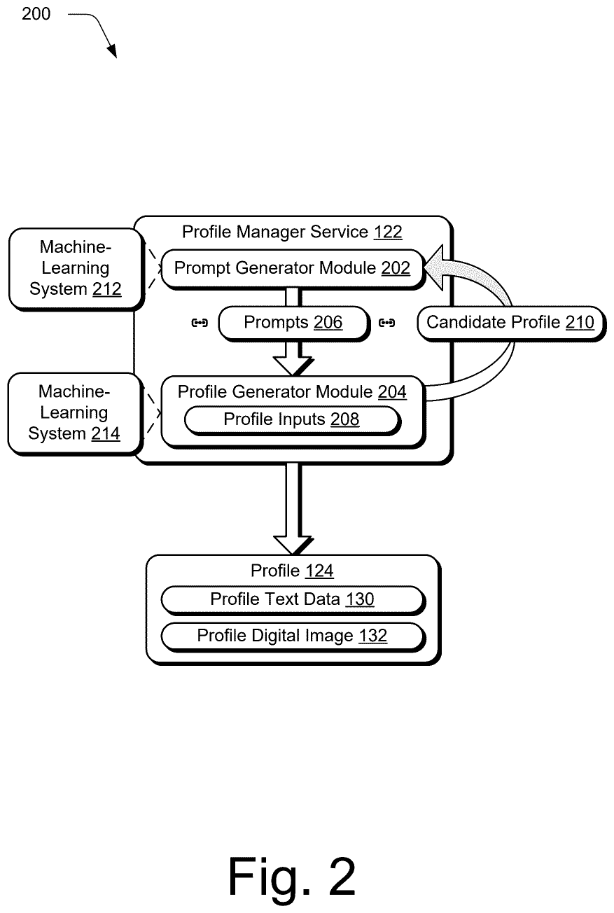

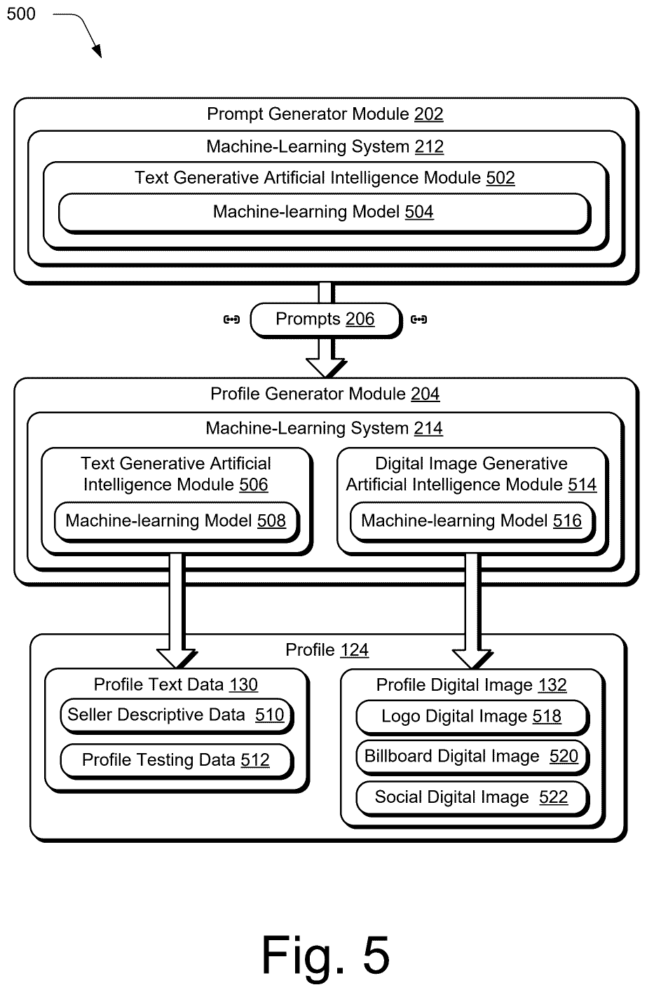

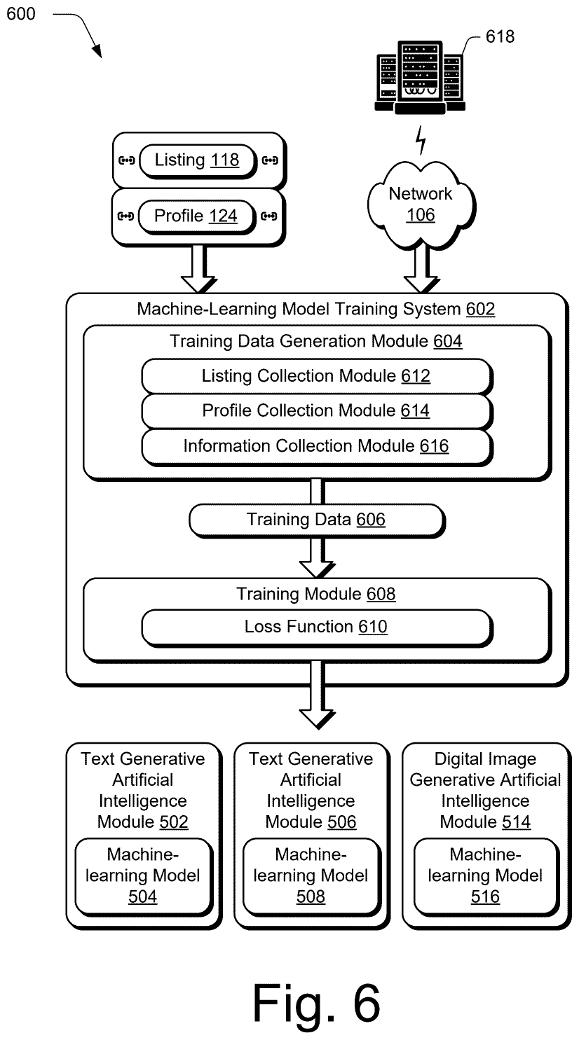

FIG. 2 depicts a system 200 in an example implementation showing operation of the profile manager service 122 of FIG. 1 in greater detail. The prompt manager service 122 includes a prompt generator module 202 and a profile generator module 204. The prompt generator module 202 is configured to generate prompts 206 that are output for display in a user interface. Profile inputs 208 received responsive to the prompts 206 are used by the profile generator module 204 to generate candidate profiles 210. The prompt generator module 202 and/or the profile generator module 204 may be implemented using a variety of functionalities, illustrated examples of which include machine learning systems 212, 214 that leverage machine-learning models as part of generative artificial intelligence as further described in relation to FIGS. 5-6.

The candidate profiles 210 are then used in this example (e.g., along with addition profile inputs 208) by the prompt generator module 202 as a basis to form additional prompts 206. The additional prompts 206 are used again by the profile generator module 204 to generate an additional candidate profile 210. Thus, in this example the profile manager service 122 is configured to implement an iterative technique to generate and refine the candidate profile 210 to obtain a profile of interest as managed by the prompts 206.

In this way, the profile manager service 122 supports responsive prompt creation using unique data to build prompts based on a user's inputs. Each user input becomes a prompt's building block, enabling effortless integration of numerous data points for resource-efficient and resilient fine-tuning of the profile 124 through a series of candidate profiles 210.

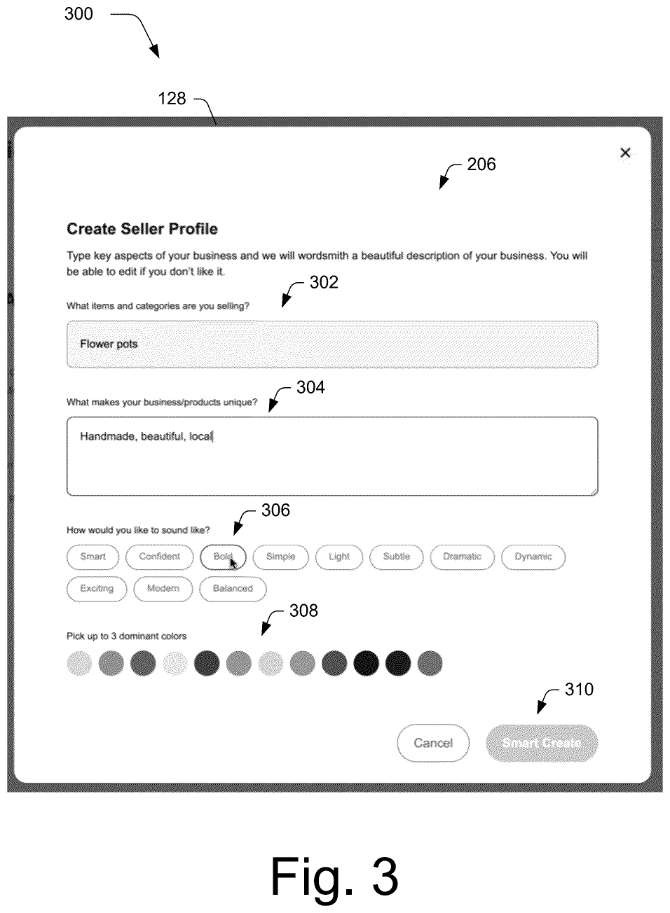

FIG. 3, for example, depicts an example implementation 300 of a first set of prompts 206 as output as an initial prompt for display in a user interface 128. The prompts include a first option 302 to input text describing items and categories that are included in listings associated with the entity. A second option 304 is also included to specify characteristics using text that make these products unique. A third option 306 supports selection of preconfigured styles to be used for text and/or digital images, e.g., “smart,” “confident,” “bold,” “simple,” “light,” “subtle,” “dramatic,” “dynamic,” “exiting,” “modern,” “balanced,” and other semantic categories. A fourth option 308 is also provided to select dominant colors to be used as part of the profile, e.g., for generation of digital images, for use in display of text, and so forth. A fifth option 310 in the user interface 128 is selectable to initiate generation of the profile. The profile inputs 208 generated through interaction with the user interface 128 are then usable by a profile generator module 204 to generate a candidate profile 210 as previously described, which is then output for display in a user interface. The candidate profile 210, for instance, is output along with additional prompts that are generated by the machine-learning model training system 602 to further refine the candidate profile to achieve a desired result.

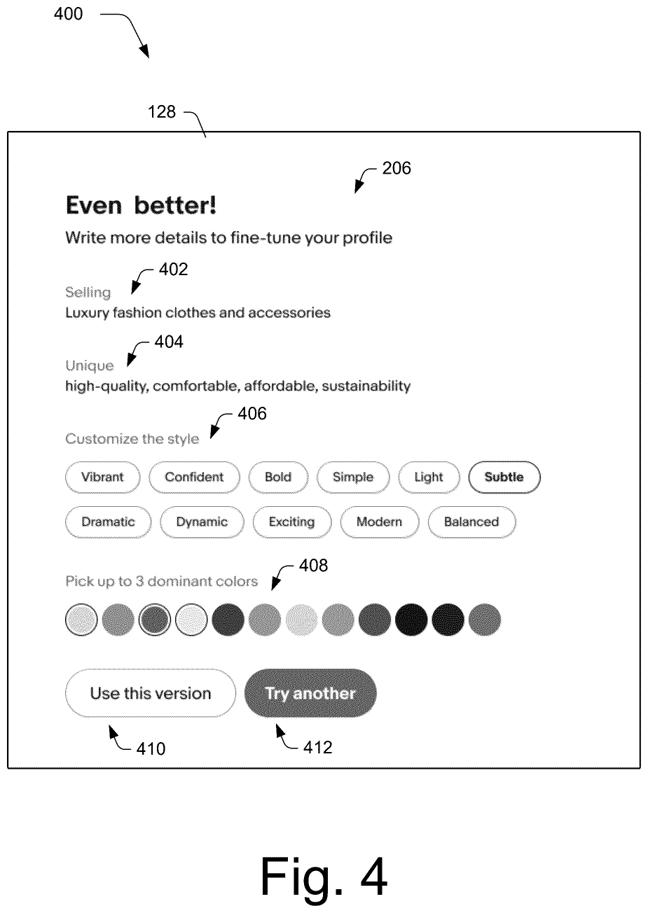

FIG. 4 depicts an example implementation 400 of a second set of prompts 206 as output for display in a user interface 128 that are usable to refine a candidate profile. The user interface 128 in this example includes an additional set of prompts 206 that are usable to further refine generation of the candidate profile 210 by the profile generator module 204.

A first option 402, for instance, includes text that is editable to further refine characteristics of a subject of the listings 118. A second option 404 includes an additional prompt to refine what differentiates the entity and/or the listings 118 from other entities or listings. A third option 406 is also provided to again customize a style, which in this scenario includes additional semantic categories that are not previously included in FIG. 4, e.g., “vibrant,” “confident,” “bold,” “simple,” “light,” “subtle,” “dramatic,” “dynamic,” “exiting,” “modern,” “balanced,” and so on. A fourth option 408 is repeated to specify colors. The user interface 128 also includes a fifth option 410 to select a currently displayed candidate profile 210 for association with an entity (e.g., a user account at the listing service 116 and/or service provider system 102) or to select a sixth option 412 to generate another candidate profile 210. Thus, the prompts 206 as generated by the prompt generator module 202 support efficient user interaction in breaking down different aspects that are usable as a basis to generate the profile 124 by the profile generator module 204.

FIG. 5 depicts a system 500 in an example implementation showing operation of the prompt generator module 202 and the profile generator module 204 of the profile manager service 122 in greater detail as employing machine learning. The prompt generator module 202 includes a machine-learning system 212 that implements a text generative artificial intelligence module 502 that leverages a machine-learning model 504 to generate prompts 206.

The profile generator module 204 also includes a text generative artificial intelligence module 506 that is configured to leverage a machine-learning model 508 to generate profile text data 130, examples of which include seller descriptive data 510. The text generative artificial intelligence module 506 is also configured to generate profile testing data 512 as executable code, e.g., to control execution of A/B testing of the profile 124 as part of the listing service 116. The profile testing data 512 is executable by the listing service 116 to determine when to alternate exposure of the candidate profile with another (e.g., existing) profile and determine a result of the exposure, e.g., conversion.

A digital image generative artificial intelligence module 514 is employed by the machine-learning system 214 of the profile generator module 204 in this example to leverage a machine-learning model 516 to generate a profile digital image 132. Examples of profile digital images 132 include a logo digital image 518, a billboard digital image 520, a social digital image 522 (e.g., for use with a social media digital service), and so forth. Thus, in this example a variety of machine-learning models 504, 508, 516 are usable by the profile manager service 122 to generate the profile 124.

A machine-learning model refers to a computer representation that is tunable (e.g., through training and retraining) based on inputs without being actively programmed by a user to approximate unknown functions, automatically and without user intervention. In particular, the term machine-learning model includes a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, generative adversarial networks (GANs), large language models, diffusion models, decision trees, support vector machines, linear regression, logistic regression, Bayesian networks, random forest learning, dimensionality reduction algorithms, boosting algorithms, deep learning neural networks, etc.

FIG. 6 depicts a system 600 in an example implementation showing training of machine-learning models usable to implement the profile manager service 122 of FIG. 1 in greater detail. The machine-learning models 504, 508, 516 are illustrated as being trained using a machine-learning model training system 602. The machine-learning model training system 602 includes a training data generation module 604 that is representative of functionality to generate training data 606. A training module 608 then uses the training data 606 to train the machine-learning models 504, 508, 516.

Machine-learning models 504, 508, 516 are configurable using a plurality of layers having, respectively, a plurality of nodes. The plurality of layers is configurable to include an input layer, an output layer, and one or more hidden layers. Calculations are performed by the nodes within the layers via hidden states through a system of weighted connections that are “learned” during training of the machine-learning models 504, 508, 508 to implement a variety of tasks, e.g., to generate profile text data 130, profile digital image 132, and so on.

In order to train the machine-learning model, training data is generated in this example by the training data generation module 604. The training data 606 provides examples of “what is to be learned” by the machine-learning models 504, 508, 516, i.e., as a basis to learn patterns from the data. The machine-learning model training system 602, for instance, collects and preprocesses the training data 606 that includes input features and corresponding target labels, i.e., of what is exhibited by the input features by respective digital images.

The machine-learning model training system 602 then utilizes the training module 608 to initialize parameters of the machine-learning models 504, 508, 516. The parameters are used by the machine-learning models 504, 508, 516 as internal variables to represent and process information during training and represent interferences gained through training. The training data 606 is used as a basis for generating predictions based on a current state of parameters of layers and corresponding nodes of the model, a result of which is output as output data. Output data describes an outcome of the task, e.g., text, a digital image, and so forth.

Training of the machine-learning models 504, 508, 516 by the training module 608 includes calculating a loss function 610 to quantify a loss associated with operations performed by nodes of the machine-learning models. The calculating of the loss function 610, for instance, includes comparing a difference between predictions specified in the output data with target labels specified by the training data. The loss function 610 is configurable in a variety of ways, examples of which include regret, Quadratic loss function as part of a least squares technique, and so forth.

Calculation of the loss function 610 also includes use a backpropagation operation as part of minimizing the loss function 610 and thereby training parameters of the machine-learning models 504, 508, 516. Minimizing the loss function 610, for instance, includes adjusting weights of the nodes in order to minimize the loss and thereby optimize performance of the machine-learning models 504, 508, 516 in performance of a particular task. The adjustment is determined by computing a gradient of the loss function 610, which indicates a direction to be used in order to adjust the parameters to minimize the loss. The parameters of the machine-learning models 504, 508, 516 are then updated based on the computed gradient.

This process continues over a plurality of iterations in an example until a stopping criterion is met. The stopping criterion is employed by the training module 608 in this example to reduce overfitting of the machine-learning models 504, 508, 516, reduce computational resource consumption, and promote an ability of the machine-learning models 504, 508, 516 to address previously unseen data, i.e., that is not included specifically as an example in the training data. Examples of a stopping criterion include but are not limited to a predefined number of epochs, validation loss stabilization, achievement of a performance improvement threshold, or based on performance metrics such as precision and recall.

The machine-learning models 504, 508 configured to implement generative artificial intelligence to generate text, for instance, are configurable as a large language model. In order to train the large language model, the training data generation module 604 collects data describing the topics and styles usable to express a profile.

Examples of functionality to implement this data collection are represented as a listing collection module 612 to collect listings from the listing service 116 and a profile collection module 614 configured to collect profiles 124 of other entities utilizing the listings 118 or other digital services. In an additional example, an information collection module 616 is configured to collect listings or other information employed by other service provider system 618 via the network 106, e.g., social media digital services, online news services, and so on. The information collection module 616, for instance, is configurable to access links using credentials for other service provider systems as provided by the entity. Once the training data 606 is collected, the training module 608 employs a loss function 610 to train the machine-learning models 504, 508 as previously described. The machine-learning models 504, 508, for instance, are trained to tokenize an input and predict tokens based on that input, which are then converted to text.

In another example, a machine-learning model 516 utilized to implement the digital image generative artificial intelligence module 514 is configurable as a diffusion model. The diffusion model is implemented using a neural network that is trained to learn to generate the profile digital image 132 by reversing a diffusion process, which is a gradual process of adding noise to data that is input to the model during training. The machine-learning model 516, and more particularly a neural network used to implement the model, learns to generate the digital images by reversing the added noise. The machine-learning models 504, 508, 506, once trained, are usable to implement a variety of functionality as part of generating the profile 124, an example of which is described as follows and shown in a corresponding figure.

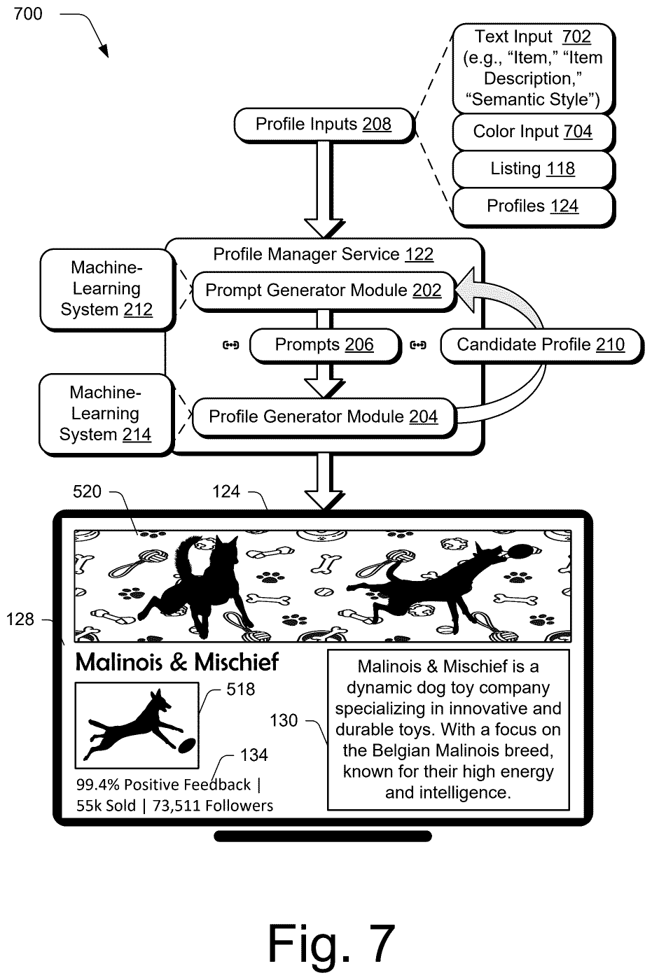

FIG. 7 depicts a system 700 in an example implementation showing artificial intelligence profile generation by a profile manager service 122 in greater detail. The profile manager service 122 in this example receives profile inputs 208 in response to prompts 206 generated by the prompt generator module 202. The prompt generator module 202, for instance, leverages the machine learning system 212 as a large language model implemented using a neural network to process profile inputs 208, such as a text input 702, color input 704, listings 118, profiles 124, and so on. The prompt generator module 202 may then generate the prompts 206 based on these inputs, which are refined over successive iterations, e.g., based on subsequent profile inputs 208 received via a user interface.

The profile inputs 208 are then utilized by the profile generator module 204 to generate the profile 124, which is displayed as output in a user interface 128. A text generative artificial intelligence module 506, for instance, employs a machine-learning model 508 as a large language model implemented using a neural network to generate profile text data 130. The profile generator module 204 may also utilize a digital image generative artificial intelligence module 514 that is configured to employ a machine-learning models 516 as a diffusion model to generate a profile digital image 132, such as a logo digital image 518, a billboard digital image 520, and so forth. In this way, the profile manager service 122 provides a robust approach and supports scalability of the service provider system 102 to address potentially millions of entities.

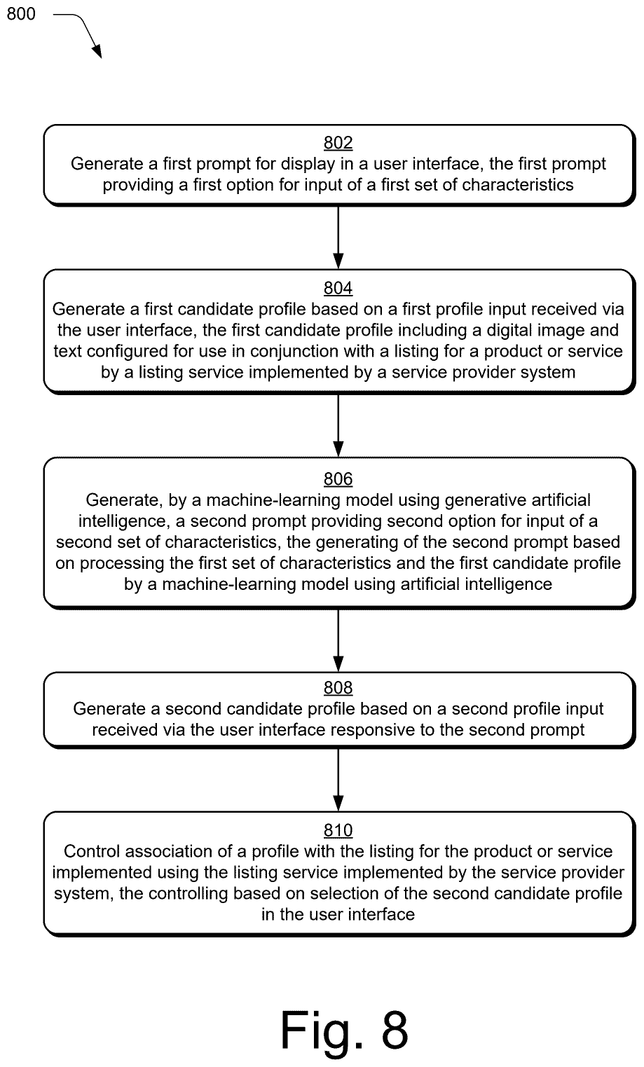

FIG. 8 is a flow diagram depicting a step-by-step procedure 800 in an example implementation of operations performable by a processing device for accomplishing a result of generating a profile using generative artificial intelligence implemented using a machine-learning model by leverage prompt generation. To begin in this example, a prompt generator module 202 generates a first prompt for display in a user interface. The first prompt provides a first option for input of a first set of characteristics (block 802). As shown in FIG. 3, for instance, the prompts 206 include a first option 302 to input text describing items and categories that are included in listings associated with the entity. A second option 304 is also included to specify characteristics using text that make these products unique. A third option 306 supports selection of preconfigured styles to be used to text and/or digital images, e.g., “smart,” “confident,” “bold,” “simple,” “light,” “subtle,” “dramatic,” “dynamic,” “exiting,” “modern,” “balanced,” and other semantic categories. A fourth option 308 is also provided to select dominant colors to be used as part of the profile, e.g., for generation of digital images, for use in display of text, and so forth. A fifth option 310 in the user interface 128 is selectable to initiate generation of the profile.

The profile inputs 208 are then received by the profile generator module 204. A first candidate profile is generated by the profile generator module 204 based on a first profile input received via the user interface. The first candidate profile includes a digital image and text configured for use in conjunction with a listing for a product or service by a listing service implemented by a service provider system (block 804), e.g., profile text data 130 and profile digital image 132 for output by the listing service 116 as part of the listings 118.

The prompt generator module 202 is then employed to generate a second prompt by a machine-learning model using generative artificial intelligence. The second prompt provides a second option for input of a second set of characteristics. Generation of the second prompt by the prompt generator module 202 is based on processing the first set of characteristics and the first candidate profile by a machine-learning model using artificial intelligence (block 806). Thus, in this example the 204 generates the second prompt based on the first candidate profile and the first set of characteristics using generative artificial intelligence, e.g., using a large language model.

The profile generator module 204, in response, generates a second candidate profile based on a second profile input received via the user interface responsive to the second prompt (block 808). Thus, the second prompt is used to invoke a second profile input that is usable to generate the second candidate profile as being a refined version of the first candidate profile. The profile manager service 122 controls association of a profile with the listing for the product or service implemented using the listing service 116 implemented by the service provider system 102. The control is based on selection of the second candidate profile in the user interface (block 810), e.g., selection of the fifth option 410 as shown in FIG. 4. Thus, in this example an iterative process involving prompts is used to generate the profile 124. Other examples of an iterative process that involves candidate profiles is also contemplated, an example of which is described as follows and is shown in a corresponding figure.

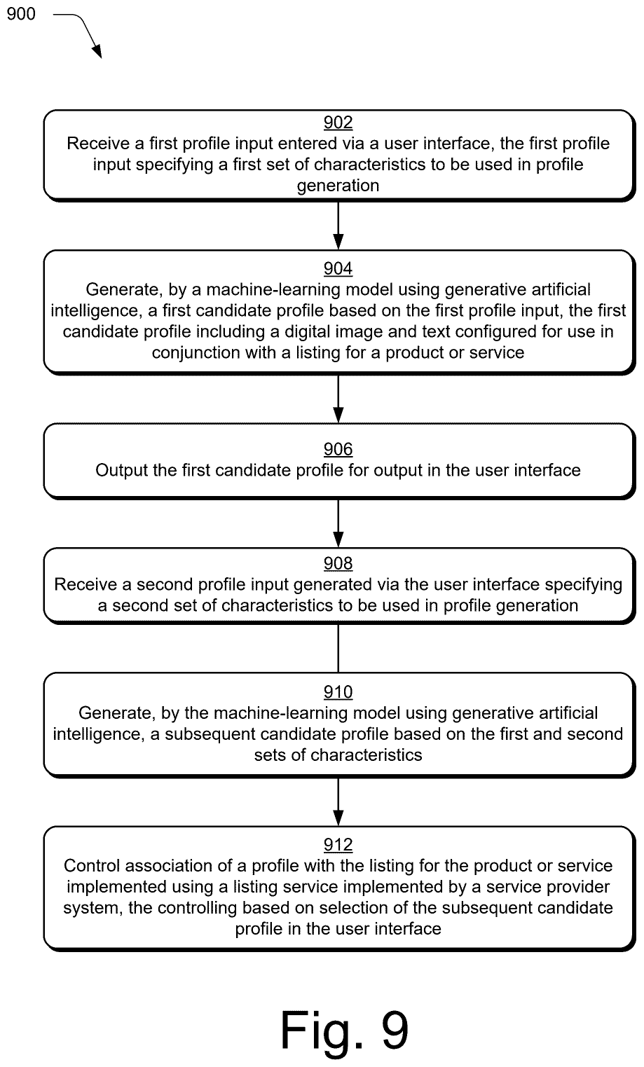

FIG. 9 is a flow diagram depicting a step-by-step procedure 900 in an example implementation of operations performable by a processing device for accomplishing a result of generating a profile using generative artificial intelligence implemented using a machine-learning model by leveraging iterative candidate profile generation. To begin in this example, a first profile input entered via a user interface is received by a profile generator module 204. The first profile input specifies a first set of characteristics to be used in profile generation (block 902), e.g., colors, semantic characteristics, product or service descriptions, and so forth.

The profile generator module 204 then generates, by a machine-learning model using generative artificial intelligence, a first candidate profile based on the first profile input. The first candidate profile includes a digital image (e.g., profile digital image 132) and text (e.g., profile text data 130) configured for use in conjunction with a listing for a product or service (block 904), e.g., to describe the entity, products or services offered by the entity as part of the listing service 116, and so forth. The first candidate profile is then output for display in a user interface (block 906), e.g., by user interface 128 as rendered by the client device 104.

A second profile input is also received by the profile generator module 204. The second profile input is generated via the user interface specifying a second set of characteristics to be used in profile generation (block 908), e.g., color, text, digital images, and so forth. The second profile input, in one or more examples, details a characteristic that is different than a characteristic included in the first profile input, e.g., different colors, text, digital images, and so forth.

In response, the profile generator module 204 generates a subsequent candidate profile based on the first and second sets of characteristics. The subsequent candidate profile is generated by the machine-learning model using generative artificial intelligence (block 910). Association of the profile is controlled by the profile manager service 122 with the listing for the product or service managed using a listing service by a service provider system. The control is based on selection of the subsequent candidate profile in the user interface (block 912), e.g., selection of the fifth option 410 as shown in FIG. 4.

### Example System and Device

FIG. 10 illustrates an example system generally at 1000 that includes an example computing device 1002 that is representative of one or more computing systems and/or devices that implement the various techniques described herein. This is illustrated through inclusion of the profile manager service 122. The computing device 1002 is configurable, for example, as a server of a service provider, a device associated with a client (e.g., a client device), an on-chip system, and/or any other suitable computing device or computing system.

The example computing device 1002 as illustrated includes a processing device 1004, one or more computer-readable media 1006, and one or more I/O interface 1008 that are communicatively coupled, one to another. Although not shown, the computing device 1002 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing device 1004 is representative of functionality to perform one or more operations using hardware. Accordingly, the processing device 1004 is illustrated as including hardware element 1010 that is configurable as processors, functional blocks, and so forth. This includes implementation in hardware as an application specific integrated circuit or other logic device formed using one or more semiconductors. The hardware elements 1010 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 1006 is illustrated as including memory/storage 1012 that stores instructions that are executable to cause the processing device 1004 to perform operations. The memory/storage 1012 represents memory/storage capacity associated with one or more computer-readable media. The memory/storage 1012 includes volatile media (such as random access memory (RAM)) and/or nonvolatile media (such as read only memory (ROM), Flash memory, optical disks, magnetic disks, and so forth). The memory/storage 1012 includes fixed media (e.g., RAM, ROM, a fixed hard drive, and so on) as well as removable media (e.g., Flash memory, a removable hard drive, an optical disc, and so forth). The computer-readable media 1006 is configurable in a variety of other ways as further described below.

Input/output interface(s) 1008 are representative of functionality to allow a user to enter commands and information to computing device 1002, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1002 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 1002. By way of example, and not limitation, computer-readable media includes “computer-readable storage media” and “computer-readable signal media.”

“Computer-readable storage media” refers to media and/or devices that enable persistent and/or non-transitory storage of information (e.g., instructions are stored thereon that are executable by a processing device) in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 1002, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1010 and computer-readable media 1006 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 1010. The computing device 1002 is configured to implement particular instructions and/or functions corresponding to the software and/or hardware modules. Accordingly, implementation of a module that is executable by the computing device 1002 as software is achieved at least partially in hardware, e.g., through use of computer-readable storage media and/or hardware elements 1010 of the processing device 1004. The instructions and/or functions are executable/operable by one or more articles of manufacture (for example, one or more computing devices 1002 and/or processing devices 1004) to implement techniques, modules, and examples described herein.

The techniques described herein are supported by various configurations of the computing device 1002 and are not limited to the specific examples of the techniques described herein. This functionality is also implementable all or in part through use of a distributed system, such as over a “cloud” 1014 via a platform 1016 as described below.

The cloud 1014 includes and/or is representative of a platform 1016 for resources 1018. The platform 1016 abstracts underlying functionality of hardware (e.g., servers) and software resources of the cloud 1014. The resources 1018 include applications and/or data that can be utilized while computer processing is executed on servers that are remote from the computing device 1002. Resources 1018 can also include services provided over the Internet and/or through a subscriber network, such as a cellular or Wi-Fi network.

The platform 1016 abstracts resources and functions to connect the computing device 1002 with other computing devices. The platform 1016 also serves to abstract scaling of resources to provide a corresponding level of scale to encountered demand for the resources 1018 that are implemented via the platform 1016. Accordingly, in an interconnected device embodiment, implementation of functionality described herein is distributable throughout the system 1000. For example, the functionality is implementable in part on the computing device 1002 as well as via the platform 1016 that abstracts the functionality of the cloud 1014.

In implementations, the platform 1016 employs a “machine-learning model” that is configured to implement the techniques described herein. A machine-learning model refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
receiving an input identifying an entity associated with a listing service, the listing service configured to provide a plurality of listings as accessible via a network;
locating one or more listings of the plurality of listings as corresponding to the entity based on the input;
generating, by a machine-learning model using generative artificial intelligence, a profile based on the one or more listings, the profile including a digital image and text configured for use in identifying the entity as part of the listing service; and
controlling association of the profile with the entity as part of the listing service.

2. The method of claim 1, wherein the machine-learning model includes a large language model implemented using a neural network to generate the text and a diffusion model to generate the digital image.

3. The method of claim 1, wherein the machine-learning model is implemented as a single multimodal large language model.

4. The method of claim 1, further comprising generating a prompt for display in a user interface, the prompt providing an option for input of a set of characteristics that are used by the machine-learning model as part of the generating to generate the profile.

5. The method of claim 4, wherein the generating of the prompt is performed using generative artificial intelligence.

6. The method of claim 4, wherein the prompt includes an option that is user selectable to specify a style or color.

7. The method of claim 1, wherein the generating includes generating a candidate profile and refining the candidate profile based on inputs received via a user interface.

8. The method of claim 1, wherein the text is based, at least in part, on text descriptions in the one or more listings as describing products or services offered by the entity via the listing service.

9. The method of claim 1, wherein the digital image is based, at least in part, on text descriptions in the one or more listings as describing products or services offered by the entity via the listing service.

10. A method comprising:
receiving a first profile input entered via a user interface, the first profile input specifying a first set of characteristics to be used in profile generation;
generating, by a machine-learning model using generative artificial intelligence, a first candidate profile based on the first profile input, the first candidate profile including a digital image and text configured for use in conjunction with a listing for a product or service;
outputting the first candidate profile for output in the user interface;
receiving a second profile input generated via the user interface specifying a second set of characteristics to be used in profile generation;
generating, by the machine-learning model using generative artificial intelligence, a subsequent candidate profile based on the first and second sets of characteristics; and
controlling association of a profile with the listing for the product or service implemented using a listing service implemented by a service provider system, the controlling based on selection of the subsequent candidate profile in the user interface.

11. The method of claim 10, wherein the profile corresponds to an entity and further comprising identifying one or more listings made available by the listing service that are associated with the entity and wherein the generating of the first candidate profile or the second candidate profile by the machine-learning model is based at least in part on the one or more listings.

12. The method of claim 11, wherein the text is based, at least in part, on descriptions in the one or more listings as describing products or services offered by the entity via the listing service.

13. The method of claim 10, wherein the digital image is a logo digital image, a billboard digital image, or a social digital image.

14. The method of claim 10, further comprising generating a prompt for display in a user interface, the prompt providing an option for input of the first set of characteristics or the second set of characteristics.

15. The method of claim 14, wherein the generating of the prompt is performed by a machine-learning model using generative artificial intelligence.

16. The method of claim 14, wherein the profile corresponds to an entity and further comprising identifying one or more listings made available by the listing service that are associated with the entity and wherein the generating of the prompt is based at least in part on the one or more listings.

17. The method of claim 16, wherein the prompt includes an option that is user selectable to specify a style or color based at least in part on the one or more listings.

18. A system comprising:
a prompt generator module implemented using generative artificial intelligence to generate prompts to guide input of characteristics to be used as part of profile generation; and
a profile generator module implemented using generative artificial intelligence to generate a candidate profile based on the characteristics received over a series of iterations in response to the prompts generated by the prompt generator module, the candidate profiles including a digital image and text configured for use in conjunction with a listing for a product or service by a listing service implemented by a service provider system.

19. The system of claim 18, wherein the candidate profile corresponds to an entity and wherein the prompt generator module is configured to generate the prompts based at least in part on one or more listings associated with the entity as part of the listing service.

20. The system of claim 18, wherein the candidate profile corresponds to an entity and wherein the profile generator module is configured to generate the candidate profiles based at least in part on one or more listings associated with the entity as part of the listing service.
